(19) United States
(12) Patent Application Publication
(10) Pub. No.: US 2006/0206650 A1
(43) Pub. Date: Sep. 14, 2006

(54) Hub with a host-to-host transmission function

(76) Inventor: Ming-Te Chang, Lujou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/204,040

(22) Filed: Aug. 16, 2005

(30) Foreign Application Priority Data
Mar. 10, 2005 (TW) 094203720

(51) Int. Cl. G06F 13/36

(52) U.S. Cl. 710/306

(57) ABSTRACT

For implementing a host-to-host transmission function, a hub comprises an uplink port and a host port for being linked a host respectively, a hub control unit connected to the uplink port, and a bridge connected between the host port and hub control unit for the hosts communicate with each other.

### FIELD OF THE INVENTION

The present invention is related generally to a hub and more particularly to a hub with a host-to-host transmission function.

### BACKGROUND OF THE INVENTION

In order to establish a communication channel between two computers, conventionally, a local area network (LAN) is employed to link the two computers, which is much inconvent for users. Currently, a USB 2.0 host-to-host transmission cable enables to establish a communication channel between two computers simpler and more efficient. USB 2.0 has a high-speed transmission rate up to 480 Mb/s, and is therefore suitable for large volumes of data transmission, which is very convenient for a computer user who needs to exchange a large amount of data. However, using a USB transmission cable inevitably occupies a USB port on the computer, and the user must prepare the USB host-to-host transmission cable in advance, both still causing inconvenience to the user.

Therefore, it is desired a device capable of easily establishing a connection between a computer and another computer.

### SUMMARY OF THE INVENTION

One object of the present invention is to provide a hub with a host-to-host transmission function.

According to the present invention, a solution is provided to overcome the drawback of conventional art, which allows a computer to easily establish a connection with another computer. In particular, a hub with a host-to-host transmission function comprises a hub control unit, an uplink port connected to the hub control unit for being linked to a first host, a host port for being linked to a second host, and a bridge connected between the host port and hub control unit for the first and second hosts to communicate with each other.

In one embodiment, the uplink port is a USB port.

In one embodiment, the host port is a USB port.

In one embodiment, the uplink port and host port are both USB ports.

In one embodiment, the hub further comprises a downlink port connected to the hub control unit for being linked to a device.

In one embodiment, the downlink port is a USB port.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a schematic view of a personal computer linked to various devices via a conventional USB hub;

FIG. 2 is a simplified illustration of a conventional USB hub;

FIG. 3 is a schematic view of a hub according to the present invention; and

FIG. 4 shows an application of a USB hub according to the present invention.

### DETAILED DESCRIPTION OF THE INVENTION

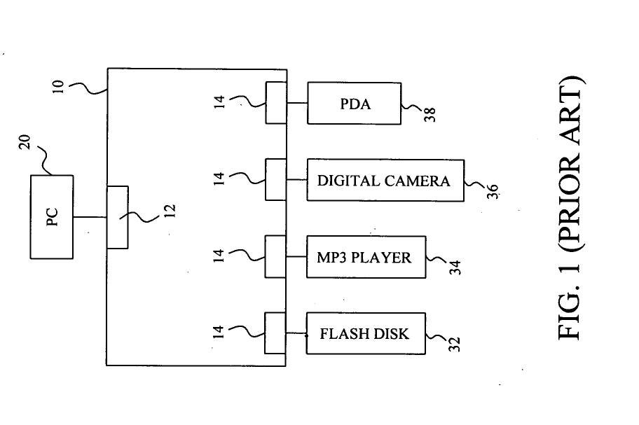

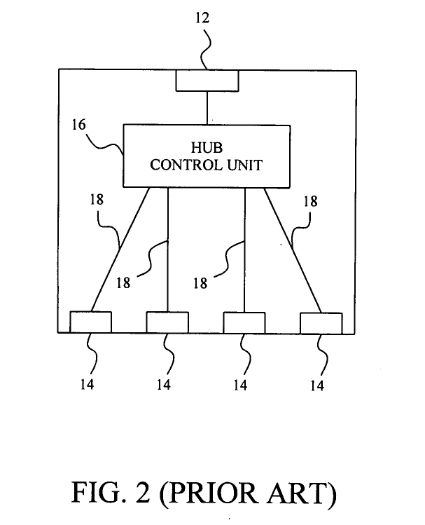

According to the present invention, a bridge available for host-to-host communications is integrated within a conventional peripheral device, i.e., hub, for example USB hub. USB hub is a popular computer peripheral device, and first of all, the operations and functions of a USB hub are illustrated briefly by FIGS. 1 and 2.

Referring to FIG. 1, a USB hub 10 has an uplink port 12 for being linked to a personal computer (PC) 20, and several downlink ports 14 for being linked to devices. Via the USB hub 10, the computer 20 can transmit data to the devices linked to the downlink ports 14, such as flash disk 32, MP3 player 34, digital camera 36, personal digital assistant (PDA) 38, and other devices, for example mouse or keyboard.

FIG. 2 shows the USB hub 10 in further details. Since USB hub is a prior art, FIG. 2 only shows a hub control unit 16 as the core of the USB hub 10. In the USB hub 10, the uplink port 12 is for being linked to a host, while the downlink ports 14 are for being linked to other devices, and with the hub control unit 16, several transmission paths may be established such that the uplink port 12 can communicate with each downlink port 14. As such, the host linked to the uplink port 12 can communicate with the devices linked to the downlink port 14.

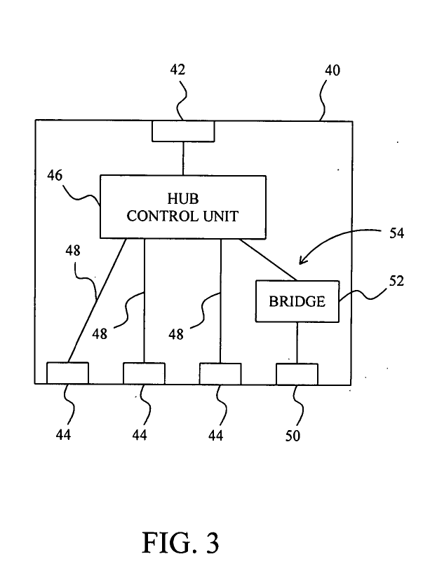

FIG. 3 shows a hub 40 according to the present invention, which has, as a conventional hub, an uplink port 42 for being linked to a host, several downlink ports 44 for being linked to devices, and a hub control unit 46 for establishing several transmission paths 48 between the uplink port 42 and downlink ports 44 such that the host linked to the uplink port 42 can communicate with the devices linked to the downlink ports 44.

However, the hub 40 further comprises a host port 50 for being linked to a host, and a bridge 52 connected between the hub control unit 46 and host port 50. The bridge 52 provides a function for host-to-host communications, and may be implemented with a bridge chip for example OTi2108 of Ours Technology Inc. or other host-to-host transmission chip. With the hub control unit 46 and bridge 52, a host-to-host transmission path 54 may be established such that the uplink port 42 may communicate with the host port 50. As such, the host linked to the uplink port 42 can communicate with the host linked to the host port 50. The host-to-host transmission mechanism is a prior art, and is not described in detail hereof.

In the hub 40, the uplink port 42, downlink ports 44, and host port 50 may be any type of transmission ports. In one embodiment, the uplink port 42 is a USB port. In another embodiment, the host port 50 is a USB port. In yet another embodiment, the uplink port 42 and host port 50 are both USB ports. In some embodiments, the downlink port 44 is a USB port. In other embodiments, the downlink port 44 is a transmission port other than USB port.

To an integrated circuit (IC) designer, it is possible to integrate the bridge 52 within the hub control unit 46, and thereby the hub control unit after integration will comprise both of a conventional hub control unit and a conventional bridge. The accompanying drawings and detailed description of the present invention are designed for illustration merely, and not intended to limit the present invention to the specific type of embodiments.

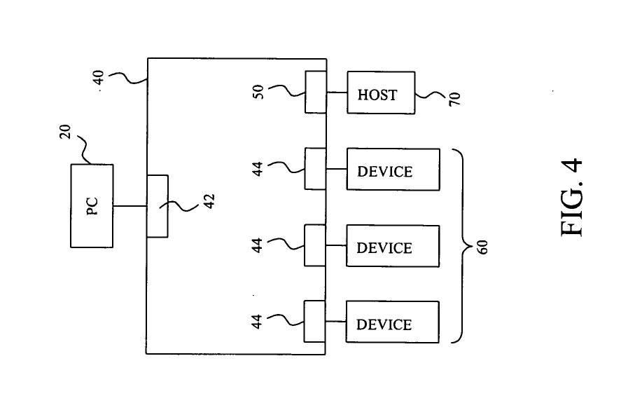

FIG. 4 shows an application of the hub 40 according to the present invention. The hub 40 in FIG. 4 is a USB hub, and the uplink port 42, downlink ports 44, and host port 50 are all USB ports. Via the USB hub 40, the personal computer 20 linked to the uplink port 42 can reach to several devices 60 linked to the downlink ports 44 in addition, such as flash disk, MP3 player, digital camera, personal digital assistant, mouse, keyboard, and other USB devices, it can further communicate with a host 70 linked to the host port 50. Particularly, the communications between the personal computer 20 and host 70 via the USB hub 40 do not need to be established based on a local area network, i.e., there is no need for any knowledge and setting regarding to local area network hereof.

A USB hub according to the present invention can overcome the drawback of conventional USB hubs that lack host-to-host transmission function. The present invention can be implemented merely by integrating or adding a bridge to a USB hub, and thus does not require too many modifications on the current hub control unit. Therefore, the derived cost is relatively low, while a multi-functional USB hub with a host-to-host transmission function is obtained.

USB hub has been a popular computer peripheral device, and thus any user of a USB hub according to the present invention will not occupy a USB port on another computer for communications therewith. The user even needs not to prepare a host-to-host transmission cable, and is not requested to setup a local area network for data exchange between the two host computers. It is a very simple and convenient way for host-to-host communications.

Although the present invention is described in the embodiments as a USB hub, one of ordinary skill in the art can easily apply the present invention to other types of hubs by selecting a suitable bridge consistent to the communication interface. Even for a wireless hub, for example disclosed by Taiwan Pat. No. 185,452, a wireless USB hub with a host-to-host transmission function can be obtained by the teaching of the present invention.

What is claimed is:

1. A hub with a host-to-host transmission function, comprising:
a hub control unit;
an uplink port connected to the hub control unit for being linked to a first host;
a host port for being linked to a second host; and
a bridge connected between the host port and hub control unit for the first and second hosts to communicate with each other.

2. The hub of claim 1, wherein the uplink port is a USB port.

3. The hub of claim 1, wherein the host port is a USB port.

4. The hub of claim 1, wherein the uplink port and host port are both USB ports.

5. The hub of claim 1, further comprising a downlink port connected to the hub control unit for being linked to a device.

6. The hub of claim 5, wherein the uplink port is a USB port.

7. The hub of claim 5, wherein the host port is a USB port.

8. The hub of claim 5, wherein the downlink port is a USB port.

9. A USB hub comprising:
a hub control unit;
a USB uplink port connected to the hub control unit for being linked to a first host;
a USB host port for being linked to a second host; and
a bridge connected between the USB host port and hub control unit for the first and second hosts to communicate with each other.

10. The USB hub of claim 9, further comprising a USB downlink port connected to the hub control unit for being linked to a device.
